(19) United States
(12) Patent Application Publication
(10) Pub. No.: US 2022/0335543 A1
(43) Pub. Date: Oct. 20, 2022

(54) SYSTEM AND METHOD FOR EMBEDDING INFORMATION RELATED TO ENERGY INTO A CRYPTO-CURRENCY BLOCKCHAIN

(71) Applicant: Alchemy Storage LLC, Whitefish, MT (US)

(72) Inventors: Marc Nathan Roston, Whitefish, MT (US); Terence Ronald Spies, Mountain View, CA (US)

(21) Appl. No.: 17/234,020

(22) Filed: Apr. 19, 2021

(51) Int. Cl. G06Q 50/06; H02J 13/00; H02J 3/38; H02J 3/00; G06Q 30/02; G06Q 20/06

(52) U.S. Cl. CPC G06Q 50/06; H02J 13/00006; H02J 3/381; H02J 3/008; G06Q 30/0202; G06Q 20/0658; H02J 2300/20; G06F 16/27

(57) ABSTRACT

A system and related methods configured to embed information into the blockchain of a mined crypto-currency. The system generally comprises a receiver attached to a crypto-currency mining device, that is in communication with a transmitter connected to a power grid or a power generator that can take information relating to the power grid or the energy production and transmit it to the receiver. The receiver will then send the information to the crypto-currency mining device to embed it into the blockchain of a mined crypto-currency. The receiver and transmitter can also take the information together with pre-defined conditions in order to determine if crypto-currency is suitable to be mined.

### FIELD OF INVENTION

The present invention relates to crypto-currency mining systems and methods, and, in particular, to a system and method of using a receiver attached to a crypto-currency mining device that is in communication with energy provisioning devices and energy grids in order to embed information relating to the energy into the blockchain of the mined crypto-currency.

### BACKGROUND

Plummeting costs and technological improvements have made renewable energy less expensive than non-renewable energy. However, assets dependent on fossil fuels have substantial remaining operational life and book value. At the same time, crypto-currencies, such as Bitcoin, have grown in popularity, consuming enormous amounts of electricity in the mining process at an exponential rate.

Currently, surplus power generation capacity from the grid may be used to inexpensively mine crypto-currencies. Conceptually, this acts as a means to “store” and “move” electricity. Fossil fuels or renewable energy sources converted into a crypto-currency when the price of power is a good range can be moved anywhere in the world. Crypto-currency can be imagined as batteries that charge quickly, move instantaneously, and discharge at any rate.

One of the shortcomings of this technology is that as long as crypto-currency prices remain high, miners have incentive to continue to use fossil fuels to produce them. Methods and systems that help crowd fossil fuel based crypto mining out of the marketplace are therefore important to help prevent the excess use of fossil fuels that are contributing to climate change.

Accordingly, a need exists for addressing the shortcomings caused by the increased mining in connection with crypto-currencies. One way to address this problem is to incentivize the use of renewable energy instead of fossil fuels to mine crypto-currencies.

The use of renewable energy to mine crypto currency will also help solve a number of other issues currently present in the field, including, without limitation improving grid stability by shifting excess power around during periods of low demand, forcing technological advances in battery benchmarking, creating efficient subsidy tools for impact investors and other stakeholders, solving net metering issues, and extending the life of less efficient computing power devices used to mine crypto-currencies.

In view of the above discussion and the shortcomings in the prior art, the invention seeks to overcome such shortcomings by providing technology offerings that ultimately make mining crypto-currency more efficient and less reliant on the use of fossil fuels.

### SUMMARY

The various embodiments provide methods and devices for embedding information relating to energy production and energy consumption into the blockchain of a mined crypto-currency. By embedding this information, users of the crypto-currency will be able to determine under which conditions the crypto-currency was mined, and more specifically, if it was mined using energy generated from a renewable resource such as solar or wind. At energy generating devices like a solar panel, wind turbine, or a coal plant, transmitters can be utilized to collect information relating to the production of energy, such as what type of energy is being produced and when, how much is being produced, and the geographical location of the energy generation. At a power grid, transmitters or transceivers can be utilized to collect information relating to the use of energy, such as what percentage of total energy being consumed by the grid is renewable, current pricing conditions, and current grid demand.

Once collected, this information can be processed and sent using the transmitter or the transceiver to a separate receiver or transceiver attached to a crypto-currency mining device. This receiver or transceiver takes the information, processes it further, and sends it to a crypto-currency mining device in order to embed the information into the blockchain of a mined crypto-currency.

Further, in one embodiment, at least one of the receiver or transceiver and crypto-currency mining device may also be configured to write the information to a secure log, which may then be stored at a secure server. The crypto-currency mining device may then embed a link to this log into the blockchain of the mined crypto-currency, which when accessed, will direct a user to the secure log in order to access the information.

In a further embodiment, pre-defined conditions can be programmed into at least one of a transmitter or transceiver attached to a power generator, a transmitter or transceiver attached to a power grid, and a receiver or transceiver attached to a crypto-currency mining device. These pre-defined conditions may comprise the price of power, the current congestion charges present on the grid, or a function of the relationship between the two. Information collected by the transmitter or transceiver, can include, but is not limited to, what type of energy is being produced and when, how much is being produced, geographical location of the energy generation, what percentage of total energy being consumed by the grid is renewable, current pricing conditions, and current grid demand, which are then compared to the pre-defined conditions. If the pre-defined conditions are met, a signal is sent to the crypto-currency mining device allowing it to mine crypto-currency. Under other sets of pre-defined conditions, a signal is sent to the crypto-currency mining device causing it to mine crypto-currency. If the conditions are not met, a signal is sent to the crypto-currency mining device either instructing it to mine crypto-currency at the mine operator's discretion, or preventing it from mining crypto-currency. These determinations on whether conditions are met to mine crypto-currency may, in certain embodiments, be calculated by either the transmitter, the transceivers, or the receiver. Further, the times and determinations made on whether crypto-currency is suitable to be mined may be embedded into the blockchain of the crypto-currency.

Additional features and advantages of the present invention are described further below. This summary section is meant merely to illustrate certain features of the invention, and is not meant to limit the scope of the invention in any way. The failure to discuss a specific feature or embodiment of the invention, or the inclusion of one or more features in this summary section, should not be construed to limit the invention as claimed.

### BRIEF DESCRIPTION OF DRAWINGS

The foregoing as well as the following detailed description of preferred embodiments of the application, will be better understood when read in conjunction with the appended drawings wherein like reference numerals refer to like components. For the purposes of illustrating the system and method of the present application, there is shown in the drawings preferred embodiments. It should be understood, however, that the application is not limited to the precise arrangement, structures, features, embodiments, aspects, and systems shown, and the arrangements, structures, features, embodiments, aspects and systems shown may be used singularly or in combination with other arrangements, structures, features, embodiments, aspects and systems. The drawings are not necessarily drawn to scale and are not in any way intended to limit the scope of this invention, but merely to clarify a single illustrated embodiment of the invention. In the drawings:

FIG. 1 is a diagram of an embodiment of a method of communication between a power grid, a power generating device, and a mining device;

FIG. 2 is a diagram of an embodiment of a method of communication between a power grid, a power generating device, and a mining device using a power control system for an installation without power storage;

FIG. 3 is a diagram of an embodiment of a method of communication between a power grid, a power generating device, and a mining device using a power control system for an installation with power storage;

FIG. 4 is a flowchart of an embodiment of a method of communication between a power grid and a mining device;

FIG. 5 is a flowchart of an embodiment of a method of communication between a power generator and a mining device;

FIG. 6 is a flowchart of an embodiment of a method of determining if crypto currency is suitable to be mined;

FIG. 7 is a flowchart of an embodiment of a method of determining if crypto currency is suitable to be mined; and

FIG. 8 is a flowchart of an embodiment of a method of storing power in a power storage device.

### DETAILED DESCRIPTION OF EMBODIMENTS

While there are shown and described fundamental novel features of the invention as applied to the illustrative embodiments thereof, it is to be understood that omissions and substitutions and changes in the form, features and details of the disclosed embodiments of the invention may be made by those skilled in the art without departing from the spirit of the invention. In this regard, it should be understood that the embodiments herein are merely illustrative, and that various features and implementation details may be omitted, combined and interchanged (including from different embodiments) and/or modified, all without departing from the spirit of the invention.

It should be noted that references herein to phrases such as “one embodiment” or “an embodiment” mean that a particular feature, structure or characteristic described in connection with the embodiment is included in at least one embodiment of the invention. The phrases such as “in one embodiment” or “in certain embodiments” in various places in the specification are not necessarily, but may be, referring to the same embodiment. Use of the term “preferred” or “preferably” is intended to indicate a configuration, set-up, feature, process, or alternative that may be perceived by the inventor(s) hereof, as of the filing date, to constitute the best, or at least a better, alternative to other such configurations, set-ups, features, processes, or alternatives. In no way shall the use of the term “preferred” or “preferably” be deemed to limit the scope of the claims hereof to any particular configuration, set-up, feature, process, or alternative.

It will be further appreciated by those skilled in the art that the figures are purely illustrative, and that the system may be implemented in any number of ways, by the actual designers, as long as the functionality as described herein, stays intact.

While there have been shown and described fundamental novel features of the invention as applied to the exemplary embodiments thereof, it will be understood that omissions and substitutions and changes in the form and details of the disclosed invention may be made by those skilled in the art without departing from the broad inventive concept thereof. It is understood, therefore, that this invention is not limited to the particular embodiments disclosed, but it is intended to cover modifications within the spirit and scope of the present invention

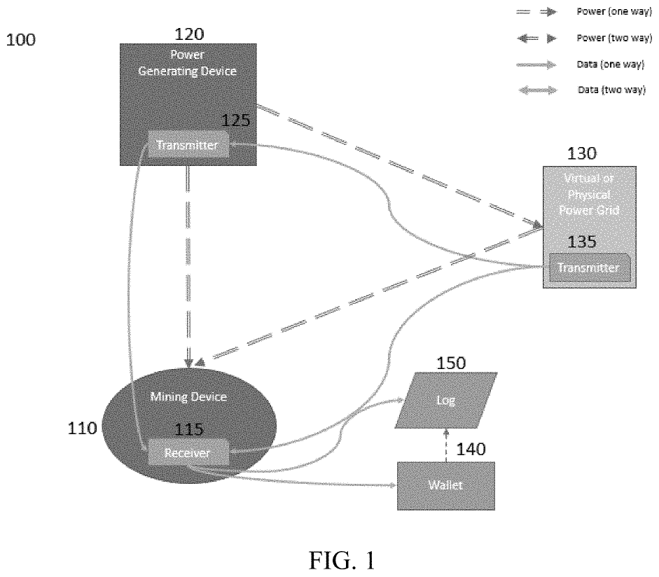

As will be understood by those skilled in the art, embodiments of the present invention may be implemented using any number of different computer and/or network-based technologies. Turning first to FIG. 1, there is shown an embodiment of a crypto-currency mining set-up with minimal structure required for operation 100. This may be accomplished for either a larger scale installation, or a distributed use installation. A larger scale installation as used herein refers to a power grid and power generating device whereby power generation is completed at a large scale, such that it can power multiple individual consumers at once. In the distributed installation embodiment, the renewable energy power generation device is subject to distributed power generation, local power consumption and remote controlling.

The crypto-currency mining set-up with minimal structure required for operation 100 generally includes a crypto-currency mining device 110, a power generating device 120, and a virtual or physical power grid 130. In general, the power generating device 120 can send power directly to the crypto-currency mining device 110, to the power grid 130, or to both at the same time.

A crypto-currency mining device as used herein refers to a device that is configured to mine crypto-currency. A crypto-currency mining device may communicate with any other device, and may be enabled to mine crypto-currency, using any type of internet connection, including, but not limited to, wireless, wired, or satellite. Crypto-currency may be any type of digital currency that is currently in use or may be created in the future. As is known by one of ordinary skill in the art, crypto-currencies are decentralized, and are operated using a distributed ledger, usually a blockchain. Blockchains contain the identifying information of the crypto-currency, such as the “wallet” information that is used to retain “ownership” of the crypto-currency, as well as to sell it. Some examples of crypto-currency include Bitcoin, Ethereum, and Tether.

A crypto-currency mining device typically comprises a power source, a motherboard, one or multiple graphics processing units (“GPU”), software modules, and a hard drive. A crypto-currency mining device may also comprise an application-specific integrated circuit (“ASIC”). Mining a crypto-currency by a crypto-currency mining device may involve using the software and hardware to verify transactions that use the crypto-currency by coming up with a hexadecimal “hash” number that is less than or equal to the target hash, or other implementation of a crypto-currency method. By solving this problem, the crypto-currency mining rig is rewarded with crypto-currency, and a block is added on to the blockchain of the crypto-currency.

It should be noted that although the embodiments described may use multiple software modules for performing the various functions of the system, other embodiments could be implemented using any number of modules, with any single module incorporating the functions of several, or all, of the modules. The precise design of the software and the programming language used may be designed differently within the scope of the present invention. The software modules may be created using art recognized programming languages, including but not limited to C++, ASP, Java, C#, Python, ASP.NET, or PHP or any combination of known or later developed programming languages that allow the functionality described.

Generally, the software functions of the computerized crypto-currency mining system and method described herein may be programmed via application software, system software or any combination thereof, and may be executable on one or more hardware components within the system, external to the system or some combination thereof. In some embodiments, system and/or application level software may reside on system hardware, various external computer systems, or some combination thereof. For example, various embodiments may be implemented with a combination of application software (i.e., a dedicated software routine) which relies on system software (i.e., an operating system and disc drivers) stored on a mainframe computer.

Alternatively and/or additionally, the methods and systems described herein may include system software (i.e., an application programming interface) stored on an external mining computer system (i.e., via an API plugin) and used by a miner application and operating system, for example, to communicate information to other aspects of the computerized crypto-currency mining system and method (i.e., an operating system) through a gateway connection.

Similarly, the implementation of various software functions described herein may at times overlap. In various embodiments, some software components may be stored in hardware residing within the system, external to the system or some combination thereof. For example, in some embodiments a software implementation may consist of a stand-alone application installed on a mainframe computer. In other embodiments, certain aspects may reside on mining hardware programmed to communicate with the crypto-currency mining system and method. Accordingly, the present invention should not be limited to the precise systems architecture described, but should be understood to include those variations as would be understood by a person of ordinary skill in the art having the benefits of the present disclosure.

A power generating device as used herein is a device that creates electricity using non-renewable or renewable resources. Non-renewable resources may comprise, but are not limited to, natural gas, coal, and oil. A non-renewable power generating device may therefore be a coal burning plant, a natural gas plant, or an oil plaint. Renewable energy resources may comprise, but are not limited to, solar, wind, water, nuclear, and geothermal. A renewable power generating device may therefore be solar panels, a wind turbine, a hydro-electric dam, or a geothermal plant. Additionally, specific regulations in geographical and political jurisdictions may be used to define which energy resources are non-renewable, and which are renewable. For example, some regions consider nuclear power renewable, while others do not.

A physical power grid as used herein refers to an energy transportation system whereby electricity is moved from one location to another using wires. A physical power grid may be a direct connection between a power generating device and an end user, or may comprise intermediate devices such as high-voltage substations and transformers.

A virtual grid as used herein is refers to a device that sends signals to at least one of a power source and a mining device that a mining device and a power source and a storage device are not connected to a physical grid. The information regarding the presence of a virtual grid usage is then recorded to the log or blockchain.

Referencing back to FIG. 1, the power generating device 120 may have a transmitter 125 attached to it, and the physical or virtual grid 130 may also have a transmitter 135 attached to it. In one embodiment, transmitters 125 and 135 may also be transceivers. These transmitters 125 and 135 may be configured to communicate with a receiver 115 attached to the crypto currency mining device 110. In one embodiment, receiver 115 may also be a transceiver. Communication may be done over the internet, using a radio-frequency signal such as Bluetooth or Cellular-Band frequency, using satellite communications, using a wired connection such as a fiber-optic cable, or by any other communication protocol known in the art. Communication may also be encrypted or non-encrypted.

A transmitter as used herein is a device configured to transmit signals either through a wired connection or wirelessly to a separate device. The transmitters can be attached to a power grid or to a power generating device either wirelessly or through a wired connection. A transmitter that transmits a wireless signal generally comprises at least one power supply as to power the device, an oscillator as to create alternating current at the frequency on which information will be transmitted, a modulator to alter a carrier wave, an amplifier to increase the power of the carrier wave, and an antenna to convert the signal to an electro-magnetic wave. Additionally, a transmitter may include a processor, internal memory, and computer software. A transmitter may also contain keying material and a cryptographic method that allows for authentication of sent messages. As appreciated by one skilled in the art, a transmitter may be comprised of any additional and distinct components that permit the transmitter to process and send information.

A receiver as used herein is a device configured to receive signals either through a wired connection or wirelessly from a separate device. The receiver can be attached to a crypto-currency mining device either wirelessly or through a wired connection. A receiver that receives a wireless signal generally comprises at least one power supply as to power the device, an antenna to capture electro-magnetic waves, an amplifier to increase the signal of the received signal, a tuner to extract signals of specific frequencies, a detector to separate information received within a signal, and an amplifier to increase the strength of the signal separated by the detector. Additionally, a receiver may include a processor, internal memory, and computer software. A receiver may also contain keying material and a cryptographic method that allows for authentication of received messages. Further, a receiver may embody tamper-resistant packaging in order to prevent spoofing of received signals. As appreciated by one skilled in the art, a receiver may be comprised of any additional and distinct components that permit the receiver to receive and process information.

A transceiver as used herein is a device configured to both receive and transmit signals either through a wired connection or wirelessly from a separate device. As can be appreciated by one of ordinary skill in the art the transceiver may be comprised of additional, the same or similar components that comprise the receiver and transmitters described previously hereto.

It will also be understood that the various embodiments of the present invention described herein can utilize electro-magnetic radio waves, a web-based centralized server architecture, an Internet-of-Things architecture, a thin client, fat client, or peer-to-peer type arrangement and substituting for the system architecture described herein are within the scope of the present invention. Additionally, the programming described herein may be stored in a machine readable form on a computer readable medium, such as a CD-ROM or DVD, and distributed to users for installation on user computers. Alternatively, such programming may be downloaded via network, and stored on a ROM or Flash memory on a system on a chip. In either embodiment, communication with the receiver may be effected across known networks, such as the Internet.

Communication between the transmitters 125 and 135 and the receiver as shown in FIG. 1 115 may comprise information related to a variety of data of both the power generating device 120 and the power grid 130. For example, the information sent by transmitter 125 attached to the power generating device 120 may comprise data regarding power generation and the type of power source. The data regarding power generation may further comprise the type or source of power generation, characteristics of a type or source of power generation, or the time and date of energy production.

Further, the data regarding the type or source of power generation may comprise whether the power source is solar, wind, hydroelectric, geothermal, nuclear, or nonrenewable. Additionally, the data regarding the characteristics of the type or source of power generation may comprise the manufacturer of generation device, the model of generation device, the serial number of generation device, installation data of the generation device, the operation cycle data of the generation device, maintenance cycle data of the generation device, the location of the generation device, or the operating conditions of the generation device. The data regarding the type of power source may further comprise an indication that power came from the grid, an indication that power did not come from the grid, characteristics of the grid power, an indication that power came from a stored power source, characteristics of the stored power source, an indication that stored power came from locally generated power, an indication that stored power came from a grid power, characteristics of the locally generated power, or characteristics of stored power that came from the power grid.

The information sent by the transmitter 135 attached to the power grid 130 may comprise data regarding grid conditions. The data regarding grid conditions may itself comprise a percentage of renewable energy being demanded by the grid, a percentage of renewable energy being supplied by the grid, a percentage of renewable energy by type being demanded by the grid, a percentage of renewable energy by type being supplied by the grid, a percentage of non-renewable energy by type being demanded by the grid, a percentage of non-renewable energy by type being supplied by the grid, an estimation of the equivalent carbon footprint of the energy being supplied by the grid, grid pricing conditions, grid demand, or an indication related to grid connection. Further, the data regarding grid demand may comprise current and forecasted prices for renewable power, by type, current and forecasted prices for non-renewable power, by type, current and forecasted congestion charges for renewable power, by type, or current and forecasted congestion charges for non-renewable power, by type. As appreciated by one skilled in the art, the information sent by both the power generating device 120 and the power grid 130 may be more expansive.

Once the information is received by receiver 115, the receiver may communicate the information to the crypto currency mining device 110 in order to embed the information into the blockchain of the crypto-currency located in the wallet of the crypto-currency 140. Communication may be accomplished by either a wired or a wireless connection without departing from the scope of the invention. To mine, a crypto-currency mining device will create a candidate block, which will contain the mining information, and the mining device will then try and find parameters that will result in this becoming a valid block on the blockchain. When a crypto-currency mining device completes the mining of a valid block of the crypto-currency, the new valid block can then be transmitted to the network as part of the blockchain.

Alternatively, the information may be written into a secure log 150, and a link to the secure log may be embedded into the blockchain of the crypto-currency located in the wallet of the crypto-currency 140. The linking allows for more detailed information (e.g., on energy usage or other mining characteristics) to be recorded and also immutably linked into the blockchain without violating block size limits. In an alternative embodiment, a hash of the log may be stored on the blockchain.

A log, as used herein, may comprise any software that allows a receiver or a crypto-currency mining device to write information into the log for later access. The log may be stored on any storage device, such as a hard drive, and may be accessed physically or over the internet. A link, such as a Uniform Resource Locator (“URL”), may be used to provide access to the log. The log may also be protected through encryption, password protection, or limitations regarding which specific software and hardware can gain access to the log.

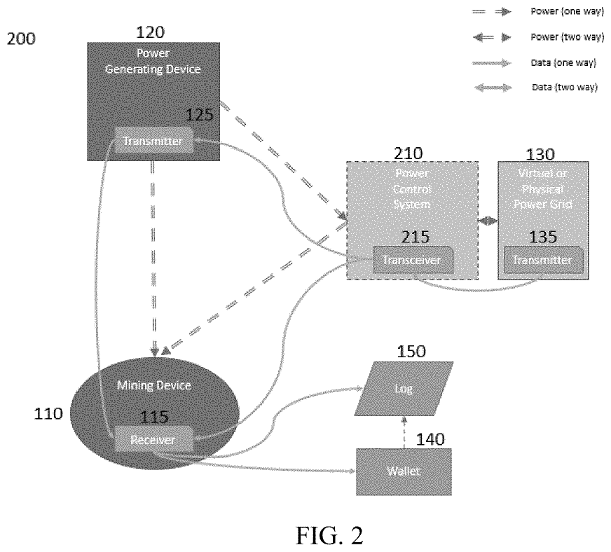

FIG. 2 shows an embodiment of a crypto-currency mining installation using a power control system for an installation without power storage 200. The power generating device 120 is connected to a power control system 210 which is then connected to the power grid 130. The power control system 210 has attached to it a transceiver 215. Transceiver 215 may alternatively be comprised of a plurality of transmitters and receivers working in conjunction with one another. The power grid 130 has attached to it transmitter 135 which may be in communication with the power control system transceiver 215. The power generating device 120 may send power to the power control system 210 which may then send it to the mining device 110, or the power generating device 120 may send the power directly to the mining device 110.

As used herein, a power control system is a combination of a grid coupling system and one or more inverters linked to a power generation device, a power storage device, a mining device, and a physical power grid. A grid coupling system consists of an alternating current coupler or a direct current coupler that ties to a physical grid, if a physical grid is present. A virtual grid does not require a grid coupling system. An inverter may be bi-directional or uni-directional. An inverter tied to a power generating device and a mining device will be uni-directional. An inverter tied to a storage device will be bidirectional. The power control system (210) may consist of the coupling system, transformer and inverters in one location, or they may be physically separated. The inverters could be physically located with the devices that require them, rather than physically located with the transformer and coupler, for example, but they operate as a unit as described herein.

Communication between the transmitters 125 and 135 and the transceiver 215 as shown in FIG. 2 may comprise information related to a variety of usage data of both the power generating device 120 and the power grid 130. The transmitters 125 and 135 may also communicate directly with receiver 115. For example, the information sent by transmitter 125 attached to the power generating device 120 may comprise the type of energy being produced, the location of the energy power generator, or the time and date of energy production, data regarding power generation and the type of power source. The data regarding power generation may further comprise the type or source of power generation, characteristics of a type or source of power generation, or the time and date of energy production. Further, the data regarding the type or source of power generation may comprise whether the power source is solar, wind, hydroelectric, geothermal, nuclear, or various methods of nonrenewable power generation. Additionally, the data regarding the characteristics of the type or source of power generation may comprise the manufacturer of generation device, the model of generation device, the serial number of generation device, installation data of the generation device, the operation cycle data of the generation device, maintenance cycle data of the generation device, the location of the generation device, or the operating conditions of the generation device. The data regarding the type of power source may further comprise an indication that power came from the grid, an indication that power did not come from the grid, characteristics of the grid power, an indication that power came from a stored power source, characteristics of the stored power source, an indication that stored power came from locally generated power, an indication that stored power came from a grid power, characteristics of the locally generated power, or characteristics of stored power that came from the power grid.

The information sent by the transmitter 135 attached to the power grid 130 may comprise data regarding grid conditions. The data regarding grid conditions may itself comprise a percentage of renewable energy being demanded by the grid, a percentage of renewable energy being supplied by the grid, a percentage of renewable energy by type being demanded by the grid, a percentage of renewable energy by type being supplied by the grid, a percentage of non-renewable energy by type being demanded by the grid, a percentage of non-renewable energy by type being supplied by the grid, grid pricing conditions, grid demand, or an indication related to grid connection percentage of renewable energy being consumed by the grid, an estimation of the equivalent carbon footprint of the energy being supplied by the grid, current grid pricing conditions, or grid demand. Further, the data regarding grid demand may comprise current and forecasted prices for renewable power, by type, current and forecasted prices for non-renewable power, by type, current and forecasted congestion charges for renewable power, by type, or current and forecasted congestion charges for non-renewable power, by type. As appreciated by one skilled in the art, the information sent by both the power generating device 120 and the power grid 130 may differ and be more or less expansive.

Once the information is received by the receiver 115, the receiver may communicate the information to the crypto currency mining device 110 in order to embed the information into the blockchain of the crypto-currency located in the wallet of the crypto-currency 140. Alternatively, the information may be written into a secure log 150, and a link to the secure log may be embedded into the blockchain of the crypto-currency located in the wallet of the crypto-currency 140.

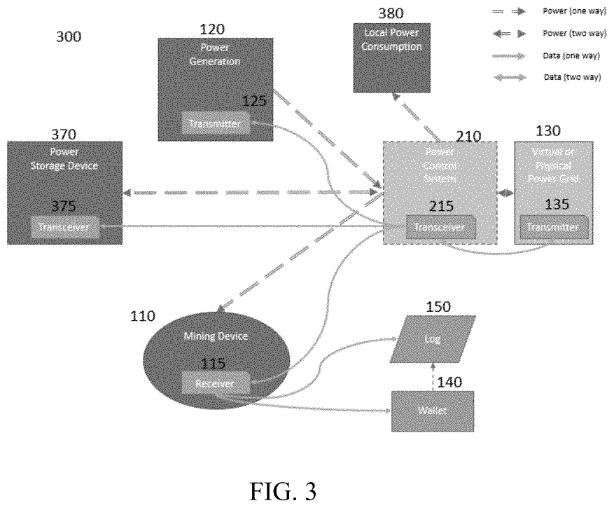

FIG. 3 shows an embodiment of a crypto-currency mining installation with a power storage device 300. The power generating device 120 is connected to a power control system 210 which is connected to the power grid 130. The power control system 210 has attached to it a transceiver 215. The power grid 130 has attached to it transmitter 135 which may be in communication with the power control system transceiver 215. The power generating device 120 may send power to the power control system 210 which may then send it to the mining device 110, or the power generating device 120 may send the power directly to the mining device 110. The power control system can also both send and receive power to the power storage device 370. Power control system 210 may also send power directly to a local power consumption 380. Power storage device 370 also has attached to it a transceiver 375 which may communicate information regarding the power storage device to the power control system transceiver 215.

As used herein, a power storage device is a device that can store and retain power for use at another time. Examples include, but are not limited to, various types of batteries, compressed gas energy storage, potential energy gravity water based storage, and hydrogen production.

As used herein, local power consumption 380 may be a power-consuming source other than the mining device 110, such as a household or a commercial building.

Communication between transmitters 125 and 135 and the transceiver 215 as shown in FIG. 3 may comprise information related to a variety of usage data of both the power generating device 120 and the power grid 130. Transmitters 125 and 135 may also communicate directly with receiver 115. For example, the information sent by transmitter 125 attached to the power generating device 120 may comprise the type of energy being produced, the location of the energy power generator, or the time and date of energy production, data regarding power generation and the type of power source.

The data regarding power generation may further comprise the type or source of power generation, characteristics of a type or source of power generation, or the time and date of energy production. Further, the data regarding the type or source of power generation may comprise whether the power source is solar, wind, hydroelectric, geothermal, nuclear, or nonrenewable. Additionally, the data regarding the characteristics of the type or source of power generation may comprise the manufacturer of generation device, the model of generation device, the serial number of generation device, installation data of the generation device, the operation cycle data of the generation device, maintenance cycle data of the generation device, the location of the generation device, or the operating conditions of the generation device. The data regarding the type of power source may further comprise an indication that power came from the grid, an indication that power did not come from the grid, characteristics of the grid power, an indication that power came from a stored power source, characteristics of the stored power source, an indication that stored power came from locally generated power, an indication that stored power came from a grid power, characteristics of the locally generated power, or characteristics of stored power that came from the power grid.

The information sent by transmitter 135 attached to power grid 130 may comprise data regarding grid conditions. The data regarding grid conditions may itself comprise a percentage of renewable energy being demanded by the grid, a percentage of renewable energy being supplied by the grid, a percentage of renewable energy by type being demanded by the grid, a percentage of renewable energy by type being supplied by the grid, a percentage of non-renewable energy by type being demanded by the grid, a percentage of non-renewable energy by type being supplied by the grid, an estimation of the equivalent carbon footprint of the energy being supplied by the grid, grid pricing conditions, grid demand, or an indication related to grid connection percentage of renewable energy being consumed by the grid, current grid pricing conditions, or grid demand. Further, the data regarding grid demand may comprise current and forecasted prices for renewable power, by type, current and forecasted prices for non-renewable power, by type, current and forecasted congestion charges for renewable power, by type, or current and forecasted congestion charges for non-renewable power, by type. As appreciated by one skilled in the art, the information sent by both the power generating device 120 and the power grid 130 may be more or less expansive.

Once the information is received by the receiver 115, the receiver may communicate the information to the crypto currency mining device 110 in order to embed the information into the blockchain of the crypto-currency located in the wallet of the crypto-currency 140. Alternatively, the information may be written into a secure log 150, and a link to the secure log may be embedded into the blockchain of the crypto-currency located in the wallet of the crypto-currency 140.

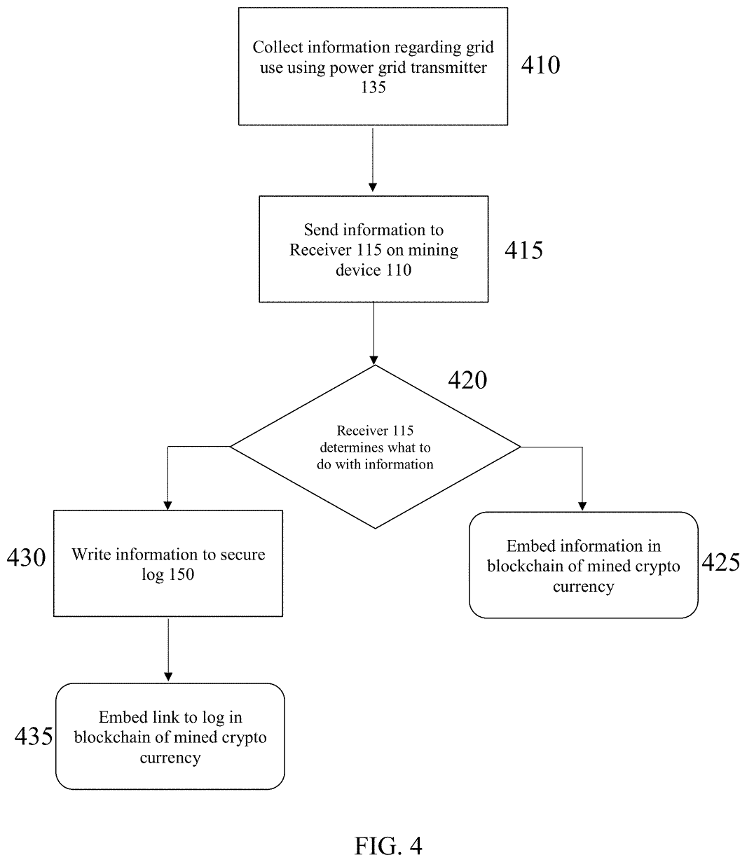

FIG. 4 shows a flowchart describing the method of embedding information into a blockchain of a mined crypto-currency according to one embodiment. In one embodiment, the power grid transmitter 135 collects information related to grid use. Step 410. The transmitter then sends the information to a receiver 115 attached to the crypto currency mining device 110. Step 415. It is then determined at the receiver what is done with the information at Step 420. The first decision is whether to have the crypto-currency mining device directly embed the information into the blockchain of the mined crypto currency. Step 425. Alternatively, the decision would be to write the information to secure log 150 Step 430, and have the crypto-currency mining device embed the link to the secure log into the blockchain of the mined crypto-currency. Step 435.

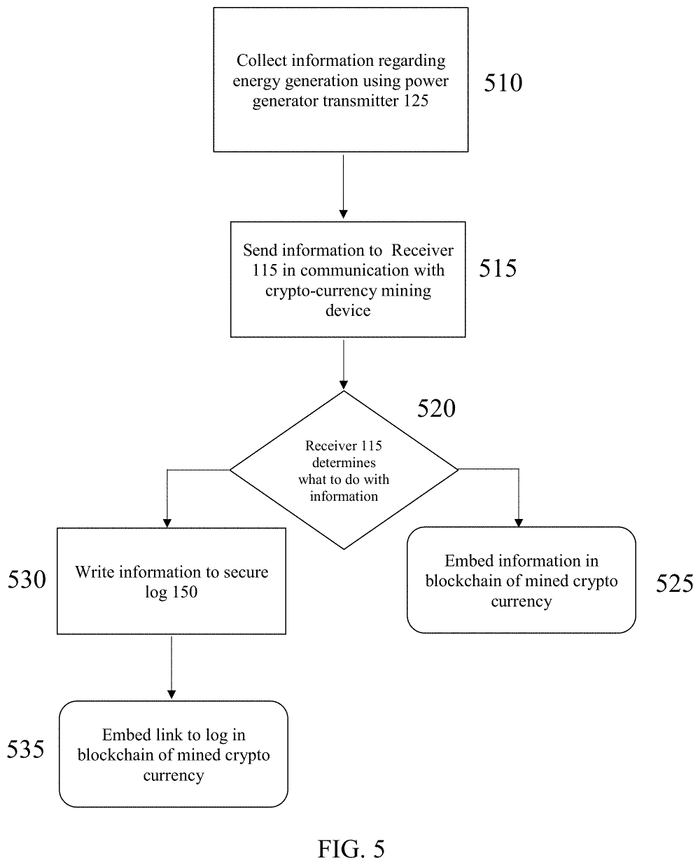

FIG. 5 shows a flowchart describing the method of embedding information into a blockchain of a mined crypto-currency, where the information relates to the generation of power using a power generating device 120. In one embodiment, the power generating device transmitter 125 collects the information relating to the generation of power. Step 510. The transmitter then sends the information to a receiver 115 attached to a crypto-currency mining device 110. Step 515. The receiver then determines what to do with the information. Step 520. The first decision is whether to have the crypto-currency mining device directly embed in the information into the blockchain of the mined crypto currency. Step 525. Alternatively, the decision would be to write the information to a secure log 150. Step 530. The link to the secure log would then be embedded into the blockchain of the mined crypto-currency. Step 535.

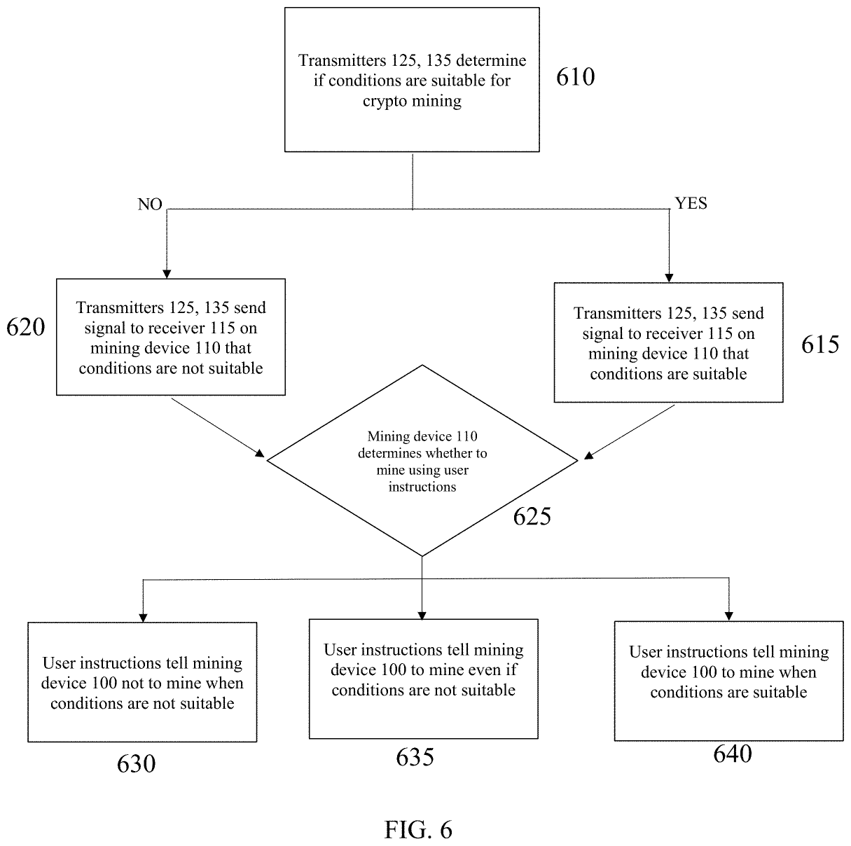

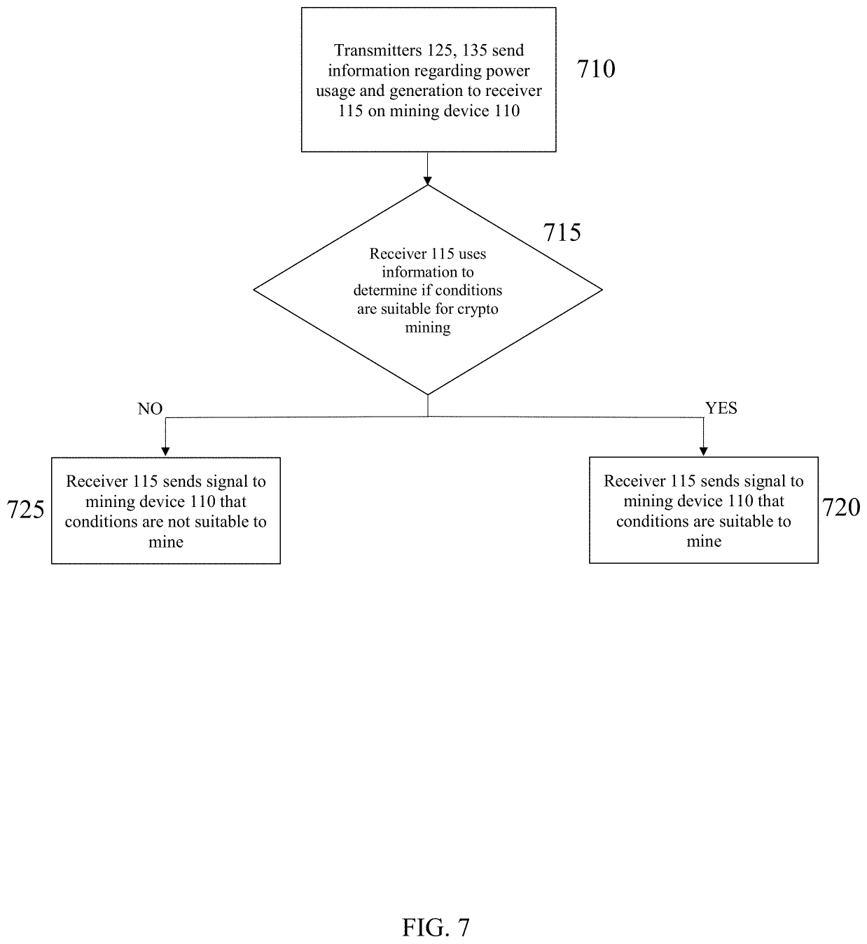

In an alternative embodiment, shown by FIGS. 6 and 7, pre-defined conditions can be used to determine which crypto-currency is best suitable for mining. Pre-defined conditions may comprise the price of power, the current congestion charges present on the grid, or a function of the relationship between the two. FIG. 6 shows an embodiment where using the transmitter 125, 135 attached to the power generating device 120 or the power grid 130 determines whether or not conditions are suitable for crypto-currency mining. The transmitter uses information gathered regarding power grid use or power generation together with the pre-defined conditions to determine if crypto-currency is suitable to be mined. Step 610. If the conditions are met, the transmitter will send a signal to the receiver 115 attached to the crypto-currency mining device 110 to mine a crypto-currency. Step 615. Alternatively, if conditions are not met, the transmitter will send a signal to the crypto-currency mining device to not mine a crypto-currency. Step 620. Once the signal is received, the mining device 110, based on user instructions, will not mine crypto-currency if the conditions are not suitable, Step 630, can choose to mine crypto-currency even if the conditions are not suitable, Step 635, or will be required to mine crypto-currency if the conditions are suitable, Step 640.

FIG. 7 shows an alternative embodiment whereby the receiver 115 attached to the crypto-currency mining device 110 determines if conditions are suitable for mining. A transmitter 125, 135 attached to either a power generating device 120 or a power grid 130 will compile and send information regarding power grid use or power generation to the receiver. Step 710. The receiver will then use the information together with pre-defined conditions to determine if crypto-currency is suitable to be mined. Step 715. If the conditions are met, the receiver will instruct the crypto-currency mining device to mine a crypto-currency. Step 720. Alternatively, if conditions are not met, the receiver will send a signal to the crypto-currency mining device to instruct it to not mine a crypto-currency. Step 725.

In both embodiments, the crypto-currency mining device can further embed the information relating to the determination on whether or not the crypto-currency was suitable to be mined into the blockchain of the crypto-currency.

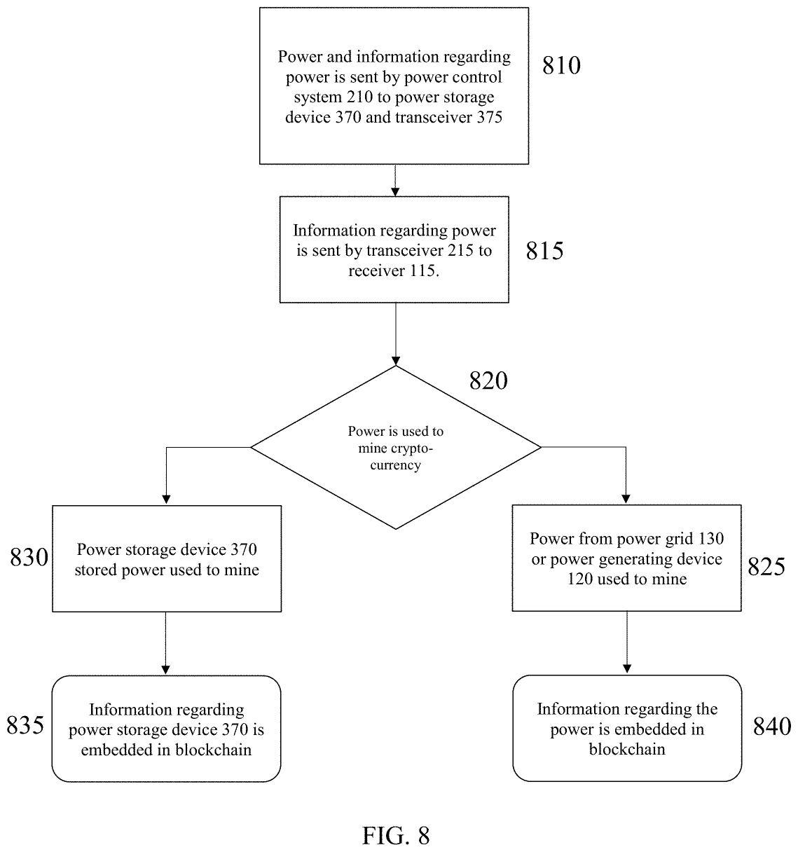

In another embodiment, shown by FIG. 8, power generated by power generating device 120 is stored in a power storage device 370. Information regarding the power is sent by transceiver 215 to transceiver 375 attached to the power storage device 370. Step 810. The same information is also sent by transceiver 215 to receiver 115. Step 815. Crypto-currency is then mined. Step 820. The crypto-currency mining can be powered either by power stored by power storage device 370, Step 830, or directly from power at the power grid 130 or from the power generating device 120, Step 825. If the mining is powered from power sent by power storage device 370, information regarding the original generation of the power is embedded in the blockchain of the mined crypto-currency. Step 835. If the mining is powered either from the power grid 130 or the power generating device 120, the information regarding the power is embedded into the blockchain of the mined crypto-currency. Step 840.

While there have been shown and described fundamental novel features of the invention as applied to the exemplary embodiments thereof, it will be understood that omissions and substitutions and changes in the form and details of the disclosed invention may be made by those skilled in the art without departing from the spirit of the invention. Hence, it is not desired to limit the invention to the exact construction and operation shown and described and, accordingly, all suitable modification equivalents may be resorted to falling within the scope of the invention as claimed. It is intended that all matter contained in the above description or shown in the accompanying drawings shall be interpreted as illustrative and not in a limiting sense. It is the intention, therefore, to be limited only as indicated by the scope of the claims appended hereto.

It is also to be understood that the following claims are intended to cover all of the generic and specific features of the invention herein described and all statements of the scope of the invention that, as a matter of language, might be said to fall there between.

What is claimed is:

1. A method of embedding information into the blockchain of a crypto currency, the method comprising:
obtaining by at least one of a transmitter and a transceiver information relating to power;
transmitting by the at least one transmitter and transceiver the information to at least one of a receiver and a transceiver in communication with a crypto currency mining device;
communicating the information by the at least one receiver and transceiver to the crypto currency mining device; and
embedding data relating to the information into the blockchain of the mined crypto currency by the crypto currency mining device.

2. The method of claim 1 further comprising:
embedding the information into a secure log.

3. The method of claim 2 whereby the data relating to the information comprises a link to the secure log.

4. The method of claim 1 whereby the information comprises at least one of:
data regarding grid conditions;
data regarding power generation; and
data regarding a power source.

5. The method of claim 4 whereby the data regarding grid conditions comprises at least one of:
a percentage of renewable energy being demanded by the grid;
a percentage of renewable energy being supplied by the grid;
a percentage of renewable energy by type being demanded by the grid;
a percentage of renewable energy by type being supplied by the grid;
a percentage of non-renewable energy by type being demanded by the grid;
a percentage of non-renewable energy by type being supplied by the grid;
an estimation of the equivalent carbon footprint of the energy being supplied by the grid;
grid pricing conditions;
grid demand; and
an indication related to grid connection.

6. The method of claim 5 whereby the data regarding grid demand comprises at least one of:
current and forecasted prices for renewable power, by type;
current and forecasted prices for non-renewable power, by type;
current and forecasted congestion charges for renewable power, by type; and
current and forecasted congestion charges for non-renewable power, by type.

7. The method of claim 4 whereby the data regarding a power source comprises at least one of an:
indication that power came from the grid;
indication that power did not come from the grid;
characteristics of the grid power;
indication that power came from a stored power source;
characteristics of a stored power source;
indication that stored power came from locally generated power;
indication that stored power came from a grid power source;
characteristics of the locally generated power; and
characteristics of stored power that came from the power grid.

8. The method of claim 4 whereby the data regarding power generation comprises at least one of:
type or source of power generation;
characteristics of a type or source of power generation;
time and date of energy production.

9. The method of claim 8 whereby data regarding the type or source of power generation comprises at least one of:
solar;
wind;
hydroelectric;
geothermal;
nuclear; and
non-renewable resources.

10. The method of claim 8 whereby data regarding the characteristics of the type or source of power generation comprises at least one of a:
manufacturer of generation device;
model of generation device;
serial number of generation device;
installation data of generation device;
operation cycle data of generation device;
maintenance cycle data of generation device;
location of generation device; and
operating conditions of generation device.

11. A receiver in communication with a crypto currency mining device, the receiver having a non-transitory computer readable medium having computer executable instructions for embedding information into a blockchain of a crypto currency, wherein execution of the program instructions by one or more processors causes the one or more processors to carry out the steps of:
receiving information relating to at least one of power grid conditions and power generation from at least one of a transmitter and a transceiver in communication with at least one of an power generator and a power grid; and
communicating the information to the crypto currency mining device whereby the crypto currency mining device is enabled to embed the information into the blockchain of a mined crypto currency.

12. The receiver of claim 11 wherein the power grid is at least one of a virtual power grid and a physical power grid.

13. The receiver of claim 11 wherein the information relating to power grid conditions comprises at least one of:
a percentage of renewable energy being demanded by the grid;
a percentage of renewable energy being supplied by the grid;
a percentage of renewable energy by type being demanded by the grid;
a percentage of renewable energy by type being supplied by the grid;
a percentage of non-renewable energy by type being demanded by the grid;
a percentage of non-renewable energy by type being supplied by the grid;
an estimation of the equivalent carbon footprint of the energy being supplied by the grid;
grid pricing conditions;
grid demand;
an indication of grid connection; and
an indication of absence of grid connection.

14. The receiver of claim 11 wherein the information relating to power generation comprises at least one of a:
type or source of energy being produced;
location of the energy power generator; and
time and date of energy production.

15. A method of mining crypto currency, the method comprising:
determining by at least one of a transmitter and a transceiver in communication with at least one of a power generator and a power grid, information relating to at least one of power generation and power grid conditions;
transmitting the information by at least one of the transmitter and the transceiver to at least one of a receiver and a transceiver in communication with a crypto currency mining device;
determining using the information and one or more pre-defined conditions whether the crypto currency should be mined; and
mining the crypto currency using the crypto currency mining device based on the determination.

16. The method of claim 15 whereby the pre-defined conditions comprise at least one of the price of power, the current congestion charges present on the grid, and a function of the relationship between the price of power and the current congestion charges present on the grid.

17. The method of claim 15 whereby the information relating to power generation comprises at least one of:
a type of energy being produced;
a location of the energy power generator; and
a time and date of energy production.

18. The method of claim 15 whereby the information relating to power grid conditions comprises at least one of:
a percentage of renewable energy being consumed by the grid;
current grid pricing conditions; and
grid demand.

19. The method of claim 15 whereby the power grid is at least one of a physical grid and a virtual grid.

20. The method of claim 17 further comprising embedding the determinations made on whether or not to mine the crypto-currency into the blockchain of the crypto-currency.
